(19) United States
(12) Patent Application Publication
(10) Pub. No.: US 2024/0146687 A1
(43) Pub. Date: May 2, 2024

(54) Gateway Handover method and Apparatus, Terminal Device and Computer Readable Storage Medium

(71) Applicant: TP-Link Corporation Limited, Hong Kong (CN)

(72) Inventors: Chaoran WANG, Hong Kong (CN); Kaiping WENG, Hong Kong (CN)

(21) Appl. No.: 18/406,242

(22) Filed: Jan. 8, 2024

Related U.S. Application Data
(63) Continuation of application No. PCT/CN2022/104231, filed on Jul. 6, 2022.

(30) Foreign Application Priority Data
Jul. 6, 2021 (CN) 202110764712.0

(51) Int. Cl. H04L 61/5014; H04L 41/0663; H04L 61/2557

(52) U.S. Cl. CPC H04L 61/5014; H04L 41/0663; H04L 61/2557

(57) ABSTRACT

Disclosed is a gateway handover method, including: monitoring a communication state of an ISP connected to a gateway to be monitored; in a case that a communication failure occurs in the ISP connected to the gateway to be monitored, selecting a repeater having a backup gateway function as a new gateway; and in response to a gateway handover operation, selecting a preset gateway handover mode for gateway handover. Also disclosed are a gateway handover apparatus, a terminal device, and a storage medium.

### CROSS-REFERENCE TO RELATED APPLICATION

The present disclosure claims priority to Patent Application no. 202110764712.0 filed on 6 Jul. 2012 and entitled “Gateway Handover method and Apparatus, Terminal Device and Computer Readable Storage Medium”, the disclosure of which is hereby incorporated by reference in its entirety.

### TECHNICAL FIELD

The present disclosure relates to the technical field of communications, and in particular, to a gateway handover method and apparatus, a terminal device, and a computer readable storage medium.

### BACKGROUND

The quality of service of network access provided by an ISP varies, and the users of the conventional access mode are completely restricted to the broadband provided by the ISP. To improve the user's network experience and ensure that users continue to enjoy network services when the broadband quality is poor or even fails, the gateway needs to be backed up. Most of the existing common gateway backup schemes are applied to industrial fields with high requirements on stability and reliability, and additional hardware components generally need to be added in a backup process, thereby causing that the schemes are not suitable for a home environment. In addition, in an implementation scheme based on an ordinary home router, a backup process only exists on a main routing device in a network system, this scheme has poor flexibility, and a user can only select a device with multiple access modes as a main route for use.

### SUMMARY

The present disclosure provides a gateway handover method and apparatus, a terminal device, and a computer readable storage medium.

A first aspect of the embodiments of the present disclosure provides a gateway handover method, including:
a communication state of an ISP connected to a gateway to be monitored is monitored;
in a case that a communication failure occurs in the ISP connected to the gateway to be monitored, a repeater having a backup gateway function is selected as a new gateway; and
in response to a gateway handover operation, a preset gateway handover mode is selected for gateway handover;
and at least one gateway handover mode includes at least one of a first gateway handover mode, a second gateway handover mode, a third gateway handover mode and a fourth gateway handover mode; the first gateway handover mode includes: the gateway to be monitored is controlled to restart and enter a relay mode, and the new gateway is controlled to restart and enter a routing mode; the second gateway handover mode includes: in cases where a original data flow logic of an internal network is maintained unchanged, a process of controlling the gateway to be monitored to forward a traffic for accessing a external network to the new gateway for processing, and a process of controlling the new gateway to forward a traffic returned by the external network to the gateway to be monitored for processing are added; the third gateway handover mode includes: the gateway to be monitored is controlled to broadcast information about the new gateway for which information configuration has been completed, so that a client transmits the traffic for accessing the external network to the new gateway; the fourth gateway handover mode includes: an IP of the gateway to be monitored and an IP of the new gateway are changed, and a DHCP server of the new gateway is turned on while a DHCP server of the gateway to be monitored is turned off.

As an improvement of the solution, the first gateway handover mode specifically includes:
the gateway to be monitored, the new gateway, and other repeaters in a networking are disconnected from the client;
the gateway to be monitored is controlled to restart and enter the relay mode, and the new gateway is controlled to restart and enter the routing mode; and
a connection of the gateway to be monitored, the new gateway and the other repeaters with the client is established.

As an improvement of the solution, the second gateway handover mode specifically includes:
the gateway to be monitored is controlled to transmit network configuration information to the new gateway; and
the new gateway is controlled to perform the information configuration according to the network configuration information, so that the new gateway forwards, according to a NAT rule, the traffic for accessing the external network to the external network, and the traffic returned by the external network is forwarded to the internal network according to the NAT rule.

As an improvement of the solution, the third gateway handover mode specifically includes:
the gateway to be monitored is controlled to transmit network configuration information to the new gateway, so that the new gateway performs the information configuration according to the network configuration information;
after the new gateway completes the information configuration, the gateway to be monitored is controlled to broadcast a DHCP message, and the DHCP message includes information about the new gateway; and
other repeaters and the client are controlled to update network configuration information thereof according to the DHCP message, so that the client transmits the traffic for accessing the external network to the new gateway.

As an improvement of the solution, the fourth gateway handover mode specifically includes:
the gateway to be monitored is controlled to transmit a client information list to the new gateway, and the client information list is lease information of the client;
a IP address of the gateway to be monitored and a IP address of the new gateway are changed, the DHCP server of the gateway to be monitored is closed, and the DHCP server of the new gateway is started;
the new gateway is controlled to broadcast the IP address which is new and a MAC address thereof.

As an improvement of the solution, in the case that the communication failure occurs in the ISP connected to the gateway to be monitored, the repeater having the backup gateway function is selected as the new gateway includes:
in the case that the communication failure occurs in the ISP connected to the gateway to be monitored, the gateway to be monitored is controlled to transmit failure information to repeaters in a networking;
the repeaters in the networking is controlled to detect a network connectivity thereof; and
the repeater having the backup gateway function is selected as the new gateway according to the network connectivity of the repeaters.

As an improvement of the solution, the method further includes: in a case that it is detected that the ISP communication connected to the gateway to be monitored is restored to be normal, a network is restored to an initial state.

A second aspect of the embodiments of the present disclosure provides a gateway handover apparatus, including:
a monitoring component configured to monitor a communication state of an ISP connected to a gateway to be monitored;
a gateway selection component, configured to select a repeater having a backup gateway function as a new gateway in a case that a communication failure occurs in the ISP connected to the gateway to be monitored;
a gateway handover component configured to select a preset gateway handover mode for gateway handover in response to a gateway handover operation;
and at least one gateway handover mode includes at least one of a first gateway handover mode, a second gateway handover mode, a third gateway handover mode and a fourth gateway handover mode; the first gateway handover mode includes: the gateway to be monitored is controlled to restart and enter a relay mode, and the new gateway is controlled to restart and enter a routing mode; the second gateway handover mode includes: in cases where a original data flow logic of an internal network is maintained unchanged, a process of controlling the gateway to be monitored to forward a traffic for accessing a external network to the new gateway for processing, and a process of controlling the new gateway to forward a traffic returned by the external network to the gateway to be monitored for processing are added; the third gateway handover mode includes: the gateway to be monitored is controlled to broadcast information about the new gateway for which information configuration has been completed, so that a client transmits the traffic for accessing the external network to the new gateway; the fourth gateway handover mode includes: an IP of the gateway to be monitored and an IP of the new gateway are changed, and a DHCP server of the new gateway is turned on while a DHCP server of the gateway to be monitored is turned off.

A third aspect of the embodiments of the present disclosure provides a terminal device, including a processor, a memory, and a computer program stored in the memory and configured to be executed by the processor when executing the computer program, and the processor implements the gateway handover method according to any one of the described first aspect.

A fourth aspect of the embodiments of the present disclosure provides a computer readable storage medium, and the computer readable storage medium includes a stored computer program, and when the computer program runs, a device where the computer readable storage medium is located is controlled to execute the gateway handover method according to any one of the first aspect.

### BRIEF DESCRIPTION OF THE DRAWINGS

FIG. 1 is a flowchart of a preferred embodiment of a gateway handover method provided by a first aspect of an embodiment of the present disclosure;

FIG. 2 is a data flow diagram of communication between other clients except a client of a new gateway itself and an external network after a gateway is handed over according to a first aspect of an embodiment of the present disclosure;

FIG. 3 is a structural block diagram of a gateway handover apparatus according to a second aspect of an embodiment of the present disclosure;

FIG. 4 is a structural block diagram of another gateway handover apparatus according to a second aspect of an embodiment of the present disclosure;

FIG. 5 is a structural block diagram of another gateway handover apparatus according to a second aspect of an embodiment of the present disclosure;

FIG. 6 is a structural block diagram of another gateway handover apparatus according to a second aspect of an embodiment of the present disclosure;

FIG. 7 is a structural block diagram of another gateway handover apparatus according to a second aspect of an embodiment of the present disclosure;

FIG. 8 is a structural block diagram of another gateway handover apparatus according to a second aspect of an embodiment of the present disclosure;

FIG. 9 is a structural block diagram of another gateway handover apparatus according to a second aspect of an embodiment of the present disclosure;

FIG. 10 is a structural block diagram of a terminal device according to a third aspect of an embodiment of the present disclosure.

### DETAILED DESCRIPTION OF THE EMBODIMENTS

Hereinafter, the technical solutions in the embodiments of the present disclosure will be described clearly and thoroughly with reference to the accompanying drawings of the embodiments of the present disclosure. Obviously, the embodiments as described are only some of the embodiments of the present disclosure, and are not all of the embodiments. On the basis of the embodiments in the present disclosure, all other embodiments obtained by a person of ordinary skill in the art without inventive effort shall all belong to the scope of protection of the present disclosure.

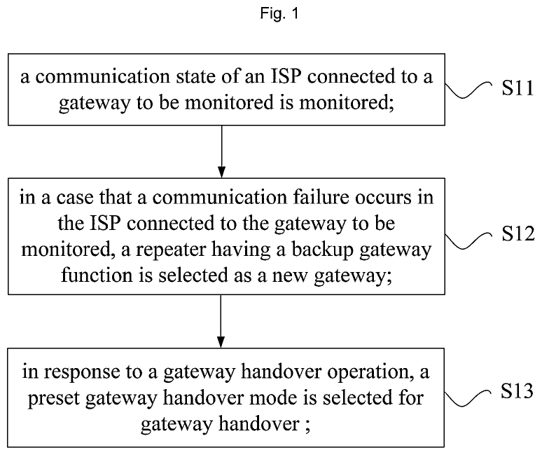

A first aspect of an embodiment of the present disclosure provides a gateway handover method. A repeater in a network system can be used as a new gateway, and when a communication failure occurs in the ISP connected to the gateway to be monitored, an appropriate gateway handover mode is selected to perform gateway handover, thereby improving the adaptability of gateway backup. Referring to FIG. 1, it is a flowchart of a preferred embodiment of a gateway handover method provided by an aspect of the present disclosure. The method includes steps S11-S13:
S11, a communication state of an ISP connected to a gateway to be monitored is monitored;
S12, in a case that a communication failure occurs in the ISP connected to the gateway to be monitored, a repeater having a backup gateway function is selected as a new gateway; and
S13, in response to a gateway handover operation, a preset gateway handover mode is selected for gateway handover;
and at least one gateway handover mode includes at least one of a first gateway handover mode, a second gateway handover mode, a third gateway handover mode and a fourth gateway handover mode; the first gateway handover mode includes: the gateway to be monitored is controlled to restart and enter a relay mode, and the new gateway is controlled to restart and enter a routing mode; the second gateway handover mode includes: in cases where a original data flow logic of an internal network is maintained unchanged, a process of controlling the gateway to be monitored to forward a traffic for accessing a external network to the new gateway for processing, and a process of controlling the new gateway to forward a traffic returned by the external network to the gateway to be monitored for processing are added; the third gateway handover mode includes: the gateway to be monitored is controlled to broadcast information about the new gateway for which information configuration has been completed, so that a client transmits the traffic for accessing the external network to the new gateway; the fourth gateway handover mode includes: an IP of the gateway to be monitored and an IP of the new gateway are changed, and a DHCP server of the new gateway is turned on while a DHCP server of the gateway to be monitored is turned off.

Specifically, the embodiments of the present disclosure are applicable to a system having a gateway to be monitored and a number of repeaters having a new gateway function, and the method may be executed by the gateway to be monitored.

The gateway to be monitored detects the running state thereof by regularly or irregularly monitoring a DNS domain name resolution request transmitted by the user and a response returned by the ISP according to the received DNS domain name resolution request, or monitoring the web page download status of the user;
in a case that the gateway to be monitored cannot detect, within a preset time, the response returned by the IPS according to the received DNS domain name resolution request or an error occurs in the returned response, or it is detected, within a preset time, that the web page has not been completely downloaded accurately, the gateway to be monitored determines that a communication failure occurs in the ISP connected thereto, and selects one of several repeaters having the backup gateway function as the new gateway;
in response to the gateway handover operation, the gateway to be monitored selects a preset gateway handover mode to perform gateway handover on the gateway to be monitored and the selected new gateway.

Optionally, the method may also be executed by an additionally provided external controller, which is not limited herein.

Optionally, the gateway handover operation may be that a user or a manufacturer sets a handover rule for several stored gateway handover modes in advance, when it is detected that the communication failure occurs in the ISP connected to the gateway to be monitored, a gateway handover mode is selected according to the handover rule, or when it is detected that the communication failure occurs in the ISP connected to the gateway to be monitored, a user may select a handover mode by means of a pop-up window but not limited to a pop-up window, and then the gateway is handed over according to the received user selection.

In some embodiments, when the system includes the first gateway handover mode and the second gateway handover mode, a handover rule may be: in a case that it is detected that the communication failure occurs in the ISP connected to the gateway to be monitored, if a duration to the last gateway handover exceeds a preset duration, it indicates that the failure rule of the gateway to be monitored is less than a preset failure rule threshold, and the first gateway handover mode which performs complete handover but takes a long time is selected; if the duration to the last gateway handover does not exceed the preset duration, it indicates that the failure rule of the gateway to be monitored is not lower than the preset failure rule threshold, and the gateway handover is performed by the second gateway handover mode which consumes a short time, performs seamless gateway handover for a client and performs incomplete handover.

It should be noted that the handover rule is not limited to the above specific rules, and may be set according to actual situations.

Compared with the prior art, the embodiments of the present disclosure disclose a gateway handover method. By monitoring a communication state of an ISP connected to a gateway to be monitored, when a communication failure occurs in the ISP connected to the gateway to be monitored, a repeater having a backup gateway function is selected as a new gateway, and furthermore, in response to a gateway handover operation, a preset gateway handover mode is selected to perform gateway handover, at least one gateway handover mode includes at least one of a first gateway handover mode, a second gateway handover mode, a third gateway handover mode and a fourth gateway handover mode, and the first gateway handover mode is: controlling the gateway to be monitored to restart and enter a relay mode, and controlling the new gateway to restart and enter a routing mode; the second gateway handover mode is: in cases where the original data flow logic of an internal network is maintained unchanged, adding processes of controlling the gateway to be monitored to forward the traffic for accessing the external network to the new gateway for processing, and controlling the new gateway to forward traffic returned by the external network to the gateway to be monitored for processing; the third gateway handover mode is: controlling the gateway to be monitored to broadcast information about the new gateway for which information configuration has been completed, so that a client transmits traffic for accessing the external network to the new gateway; and the fourth gateway handover mode is: changing the IP of the gateway to be monitored and the IP of the new gateway, and turning on the DHCP server of the new gateway while turning off the DHCP server of the gateway to be monitored. Hence, in the embodiments of the present disclosure, a repeater in a network system can be used as a new gateway, and when a communication failure occurs in the ISP connected to the gateway to be monitored, an appropriate gateway handover mode is selected to perform gateway handover, thereby improving the adaptability of gateway backup.

In another embodiment, the first gateway handover mode specifically includes step S131a to S133a:
S131a, the gateway to be monitored, the new gateway, and other repeaters in the networking are disconnected from the client;
S132a, the gateway to be monitored is controlled to restart and enter the relay mode, and the new gateway is controlled to restart and enter the routing mode; and
S133a, a connection of the gateway to be monitored, the new gateway and the other repeaters with the client is established.

In some embodiments, the gateway to be monitored and all the repeaters disconnect from all the clients, then the gateway to be monitored enters a relay mode, other repeaters except the new gateway enter a detection mode, and the new gateway enters a routing mode; a repeater in a detection mode detects how routing devices in a networking system form a network, and enables, by means of detection, the repeater in a detection mode to find a new gateway in a routing state or a routing device connected to the new gateway in a routing mode, to re-complete networking and form a child-mother routing network; detection refers to perceiving the existence of a main node (a new gateway in a routing mode) and establishing a network internal communication (Backhaul) with the main node; after networking is completed, the gateway to be monitored, the new gateway and other repeaters re-establish a connection with the client.

It should be noted that all repeaters in the system and the gateway to be monitored constitute a routing system, the initial state of the gateway to be monitored is a routing mode, and the initial state of all repeaters is a relay mode. In the present embodiment, a device in a relay mode is always searching for a device in a routing mode, or searching for a device in a relay mode which has been connected to a device in a routing mode; therefore, in cases where the routing system disconnects with all clients, the original routing connection relationship is just maintained, without specifically disconnecting with each device in the routing system, and after the gateway to be monitored is restarted to enter the relay mode and a new gateway is restarted to enter the routing mode, since the state of the gateway to be monitored changes to be a relay mode, the original routing connection relationship cannot satisfy the direct or indirect connection between all devices in the relay mode and the device in the routing mode; and therefore, the device in the relay mode will research for and establish a direct or indirect connection with the new gateway currently in the routing mode, and the routing connection relationship further changes.

It should be noted that, the DHCP server which performs gateway handover by the first gateway handover mode switches from the gateway to be tested to the new gateway.

In yet another embodiment, the second gateway handover mode specifically includes step S131b to S132b:
S131b, the gateway to be monitored is controlled to transmit network configuration information to the new gateway; and
S132b, the new gateway is controlled to perform the information configuration according to the network configuration information, so that the new gateway forwards, according to a NAT rule, the traffic for accessing the external network to the external network, and the traffic returned by the external network is forwarded to the internal network according to the NAT rule.

In some embodiments, the gateway to be monitored transmits the network configuration information stored therein to the new gateway, the network configuration information including but not limited to a source IP, a destination IP, a source port, a destination port, various communication protocols, etc. which are recorded in the gateway to be monitored; The new gateway performs information configuration according to the network configuration information transmitted by the gateway to be monitored, so that the new gateway forwards, according to the NAT rule, the traffic for accessing the external network to the external network, and forwarding, to the internal network, the traffic returned by the external network according to the NAT rule.

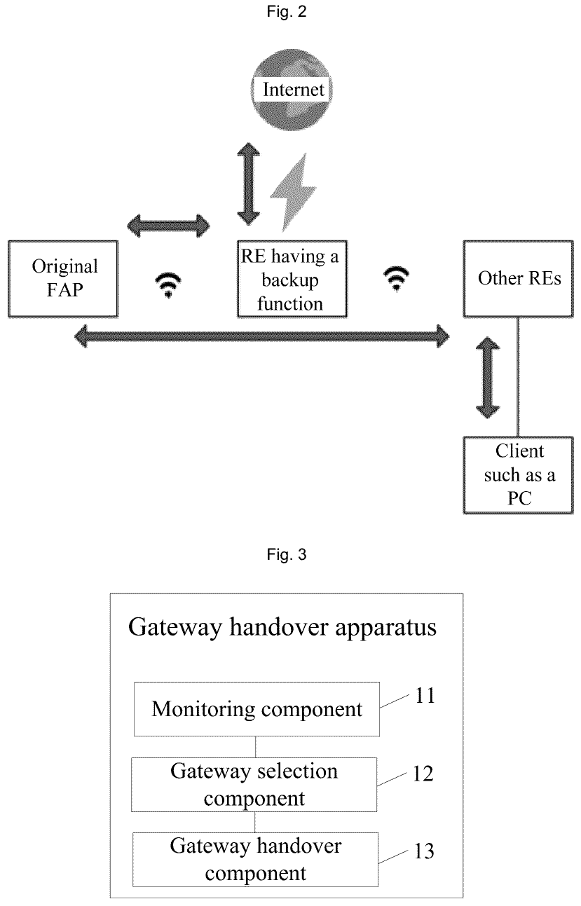

In some embodiments, referring to FIG. 2 which is a data flow diagram of communication between other clients except a client of a new gateway itself and an external network after a gateway is handed over; in addition to a client of an RE (a new gateway) itself having a backup function, the traffic of other clients accessing the Internet (the external network) is forwarded to an original FAP according to a data flow direction before gateway handover, then is forwarded to an RE having a backup function by the original FAP, and then is forwarded to the external network by the RE having the backup function according to the NAT rule; when the RE having the backup function receives the traffic returned by the Internet, the RE forwards same to the gateway to be monitored according to the NAT rule, and then the gateway to be monitored transmits same to a corresponding client according to a data flow direction before gateway handover; the client of the new gateway itself refers to a client to which data that needs to be forwarded by the new gateway belongs when the client performs data transmission with an external network before gateway handover. The FAP refers to a device serving as a gateway in an internal network, a corresponding control system runs on the FAP, and can control an RE in the internal network, such as the rate of the Backhaul, on and off of a wireless Wi-Fi, on and off of an LED, and a networking password; besides the normal relay function, the RE may also respond to various operation commands issued by the FAP; in the present embodiment, the FAP and the RE may be the same in hardware, and the functions of the two may be controlled by software, so that mode switching may be performed on the FAP and the RE that has a backup function according to actual requirements.

The data flow direction of the communication between the client of the new gateway itself and the external network is that: the client of the new gateway itself transmits a traffic for accessing the external network to the new gateway, and the new gateway forwards the traffic to the external network; the traffic returned by the external network to the client of the new gateway is received by the new gateway and forwarded to the corresponding client of the new gateway.

It should be noted that the DHCP server that performs gateway handover by the second gateway handover mode is still on the gateway to be monitored.

In yet another embodiment, the third gateway handover mode specifically includes steps S131c to S133c:
S131c, the gateway to be monitored is controlled to transmit network configuration information to the new gateway, so that the new gateway performs the information configuration according to the network configuration information;
S132c, after the new gateway completes the information configuration, the gateway to be monitored is controlled to broadcast a DHCP message, and the DHCP message includes information about the new gateway; and
S133c, controlling other repeaters and the client to update network configuration information thereof according to the DHCP message, so that the client transmits the traffic for accessing the external network to the new gateway.

In some embodiments, the gateway to be monitored transmits a network data packet (network configuration information) to a selected temporary gateway (a new gateway), so as to enable the temporary gateway and cause the temporary gateway to perform information configuration (such as a router and a firewall) according to the network data packet; after completing information configuration, the temporary gateway transmits information indicating that information configuration has been completed to the gateway to be monitored, and after receiving from the temporary gateway the information indicating that information configuration has been completed, the gateway to be monitored broadcasts the DHCP message, and the DHCP message carries information about a new temporary gateway; after other devices (other repeaters and clients) receive the DHCP message, the other devices update their own network configuration information according to the DHCP message. Thereafter, the data transmission of the internal network and the external network is forwarded by the new gateway.

It should be noted that, when the third gateway handover mode is used to perform gateway handover, a client (such as a mobile phone or a PC) needs to adapt to a new protocol. The new protocol is to extend the existing DHCP protocol, and add a type of the DHCP message, named DHCPREOFFER(0x09); the format of the message is the same as that of DHCPOFFER; the message is actively transmitted by the DHCP server, and it is announced that parameters that the DHCP server wants to transmit to the client change (such as a default gateway change, a DNS server change, a static route change, or a change in other dhcp option fields) compared with the parameters previously received by the DHCP client; the message is actively transmitted by the DHCP server, and requests that the DHCP client in a BOUND state can respond to the type of the DHCP message. In addition, the type of message does not set a transaction ID. After receiving the type of message, the client should ignore the field, and then the client can independently choose to enter a DISCOVER state, or directly accept the parameters in the DHCPREOFFER message and enter a REQUESTING state.

It should be noted that the DHCP server that performs gateway handover by the third gateway handover mode is still on the gateway to be monitored.

In yet another embodiment, the fourth gateway handover mode specifically includes steps S131d to S133d:
S131d, the gateway to be monitored is controlled to transmit a client information list to the new gateway, and the client information list is lease information of the client;
S132d, an IP address of the gateway to be monitored and an IP address of the new gateway are changed, the DHCP server of the gateway to be monitored is closed, and the DHCP server of the new gateway is started;
S133d, the new gateway is controlled to broadcast the IP address which is new and a MAC address thereof.

In some embodiments, the client information list stored in the gateway to be monitored is transmitted to the new gateway; and the client information list is lease information of the client, is information related to DHCP Lease, and includes all the necessary information such as an allocated client IP, a corresponding MAC and a lease; relevant information about the DHCP server itself, such as an address pool range, is always synchronous on various devices (including a gateway to be monitored, a new gateway and other repeaters) in an internal network, and is an inherent function already realized by the network system of the present embodiment; when being updated in a synchronization mechanism, the configuration will be transmitted to other devices by means of an inherent mechanism; each device has a set of complete configurations; if a certain configuration needs to be synchronized, the configuration item can be added to the original synchronization mechanism; the IP of the gateway to be monitored is set as the IP of the current new gateway, then the DHCP server of the gateway to be monitored is closed, the IP of the new gateway itself is set as the original IP of the gateway to be monitored, and then the DHCP server of the new gateway is enabled; the new gateway broadcasts the new IP address and the MAC address thereof, and announces a binding relationship between the current IP address and the MAC address thereof, so that a client (a mobile phone, a PC, etc.) can still directly transmit the traffic for accessing the Internet to the new gateway according to default gateway information which is previously acquired thereby. It is almost a seamless gateway handover to the client; and the new gateway replaces, according to a synchronized client information list, the gateway to be monitored to begin to execute a work which should be undertaken by a normal DHCP server.

In yet another embodiment, in the case that the communication failure occurs in the ISP connected to the gateway to be monitored, the repeater having the backup gateway function is selected as the new gateway specifically includes steps S121 to S123:
S121, in the case that the communication failure occurs in the ISP connected to the gateway to be monitored, the gateway to be monitored is controlled to transmit failure information to repeaters in a networking;
S122, the repeaters in the networking is controlled to detect a network connectivity thereof; and
S123, the repeater having the backup gateway function is selected as the new gateway according to the network connectivity of the repeaters.

In some embodiments, when it is detected that the gateway to be monitored is in a network failure, the gateway to be monitored transmits a message to a repeater in a network according to a network information list recorded thereon to report its own network failure, so that the repeater transmits, within a specified time, its own connectivity condition as a new gateway to the gateway to be monitored (the repeater may maintain an operation of detecting the connectivity of the Internet all the time, and may also perform detection after having received failure information reported by the gateway to be monitored); a repeater is selected as a new gateway according to the connectivity information reported by the repeaters and received by the gateway to be monitored.

In yet another embodiment, the method further includes: in a case that it is detected that the communication in the ISP connected to the gateway to be monitored is restored to be normal, a network is restored to an initial state.

In some embodiments, when it is detected that the communication of the ISP connected to the gateway to be monitored is restored to be normal, the network may be restored to an initial state according to a preset restoration manner, or a restoration manner may be selected by a user by means of a pop-up window but not limited to a pop-up window, and then the network is restored according to a received user selection.

Compared with the prior art, the gateway handover method provided in the embodiments of the present disclosure can use a repeater in a network system as a new gateway, and select an appropriate gateway handover mode to perform gateway handover when a communication failure occurs in an ISP connected to a gateway to be monitored, thereby improving the adaptability of gateway backup, and the gateway handover can be realized only on a home router without additionally adding a hardware component. The method has the advantages of low cost and being applicable to a home scenario. In addition to the first gateway handover mode, when other gateway handover modes are used to perform gateway handover, the physical connection of the internal network remains unchanged, and only logical relationships change. In particular, in the second gateway handover mode and the fourth gateway handover mode, network topology information (including default routing information of a client) stored in a client also does not change, and the second gateway handover mode and the fourth gateway handover mode can be applied to a fixed IP scenario.

A second aspect of the embodiments of the present disclosure provides a gateway handover apparatus. Refer to FIG. 3 which is a block diagram of a preferred embodiment of a gateway handover apparatus provided in the second aspect of the disclosure. The apparatus includes:
a monitoring component 11 configured to monitor a communication state of an ISP connected to a gateway to be monitored;
a gateway selection component 12, configured to select a repeater having a backup gateway function as a new gateway in a case that a communication failure occurs in the ISP connected to the gateway to be monitored;
a gateway handover component 13 configured to select a preset gateway handover mode for gateway handover in response to a gateway handover 13 operation,
and at least one gateway handover mode includes at least one of a first gateway handover mode, a second gateway handover mode, a third gateway handover mode and a fourth gateway handover mode; the first gateway handover mode includes: the gateway to be monitored is controlled to restart and enter a relay mode, and the new gateway is controlled to restart and enter a routing mode; the second gateway handover mode includes: in cases where a original data flow logic of an internal network is maintained unchanged, a process of controlling the gateway to be monitored to forward a traffic for accessing a external network to the new gateway for processing, and a process of controlling the new gateway to forward a traffic returned by the external network to the gateway to be monitored for processing are added; the third gateway handover mode includes: the gateway to be monitored is controlled to broadcast information about the new gateway for which information configuration has been completed, so that a client transmits the traffic for accessing the external network to the new gateway; the fourth gateway handover mode includes: an IP of the gateway to be monitored and an IP of the new gateway are changed, and a DHCP server of the new gateway is turned on while a DHCP server of the gateway to be monitored is turned off.

Specifically, the embodiments of the present disclosure are applicable to a system having a gateway to be monitored and several repeaters having a backup gateway function. The apparatus may be a gateway to be monitored, and may also be an added external controller, which is not limited herein.

The monitoring component 11 detects the running state thereof by regularly or irregularly monitoring a DNS domain name resolution request transmitted by the user and a response returned by the ISP according to the received DNS domain name resolution request, or monitoring the web page download status of the user;
in a case that the gateway selection component 12 cannot detect, within a preset time, the response returned by the IPS according to the received DNS domain name resolution request or an error occurs in the returned response, or it is detected, within a preset time, that the web page has not been completely downloaded accurately, the gateway to be monitored determines that a communication failure occurs in the ISP connected thereto, and selects one of several repeaters having the backup gateway function as the new gateway;
in response to the gateway handover operation, the gateway handover component selects a preset gateway handover mode to perform gateway handover on the gateway to be monitored and the selected new gateway.

In some embodiments, the gateway handover operation may be that a user or a manufacturer sets a handover rule for several stored gateway handover modes in advance, when it is detected that a communication failure occurs in the ISP connected to the gateway to be monitored, a gateway handover mode is selected according to the handover rule, or when it is detected that the communication failure occurs in the ISP connected to the gateway to be monitored, a user may select a handover mode by means of a pop-up window but not limited to a pop-up window, and then the gateway is handed over according to the received user selection.

In some embodiments, when the system includes the first gateway handover mode and the second gateway handover mode, a handover rule may be: in a case that it is detected that the communication failure occurs in the ISP connected to the gateway to be monitored, if a duration to the last gateway handover exceeds a preset duration, it indicates that the failure rule of the gateway to be monitored is less than a preset failure rule threshold, and the gateway handover is performed by the second gateway handover mode which consumes a short time, performs seamless gateway handover for a client and performs incomplete handover; if the duration to the last gateway handover does not exceed the preset duration, it indicates that the failure rule of the gateway to be monitored is not lower than the preset failure rule threshold, and the second gateway handover mode which performs complete handover but takes a long time is selected.

It should be noted that the handover rule is not limited to the above specific rules, and may be set according to actual situations.

Compared with the prior art, the embodiments of the present disclosure disclose a gateway handover apparatus. By monitoring a communication state of an ISP connected to a gateway to be monitored, when a communication failure occurs in the ISP connected to the gateway to be monitored, a repeater having a backup gateway function is selected as a new gateway, and furthermore, in response to a gateway handover operation, a preset gateway handover mode is selected to perform gateway handover, at least one gateway handover mode includes at least one of a first gateway handover mode, a second gateway handover mode, a third gateway handover mode and a fourth gateway handover mode, and the first gateway handover mode is: controlling the gateway to be monitored to restart and enter a relay mode, and controlling the new gateway to restart and enter a routing mode; the second gateway handover mode is: in cases where the original data flow logic of an internal network is maintained unchanged, adding processes of controlling the gateway to be monitored to forward the traffic for accessing the external network to the new gateway for processing, and controlling the new gateway to forward traffic returned by the external network to the gateway to be monitored for processing; the third gateway handover mode is: controlling the gateway to be monitored to broadcast information about the new gateway for which information configuration has been completed, so that a client transmits traffic for accessing the external network to the new gateway; and the fourth gateway handover mode is: changing the IP of the gateway to be monitored and the IP of the new gateway, and turning on the DHCP server of the new gateway while turning off the DHCP server of the gateway to be monitored. Hence, in the embodiments of the present disclosure, a repeater in a network system can be used as a new gateway, and when a communication failure occurs in the ISP connected to the gateway to be monitored, an appropriate gateway handover mode is selected to perform gateway handover, thereby improving the adaptability of gateway backup.

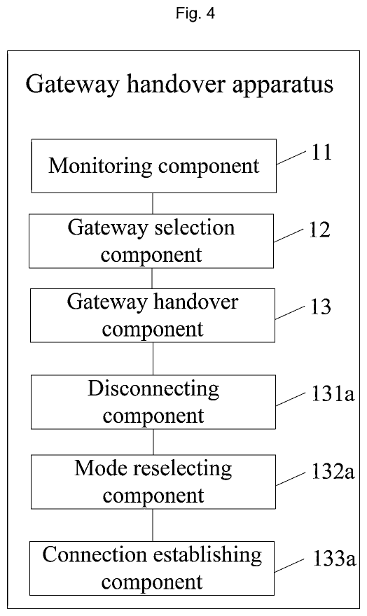

In another embodiment, referring to FIG. 4, the apparatus further includes:
a disconnecting component 131a configured to disconnect the gateway to be monitored, the new gateway, and other repeaters in the networking from the client;
a mode reselecting component 132a configured to control the gateway to be monitored to restart and enter the relay mode, and control the new gateway to restart and enter the routing mode;
a connection establishing component 133a configured to establish a connection of the gateway to be monitored, the new gateway and the other repeaters to the client.

In some embodiments, the gateway to be monitored and all the repeaters disconnect from all the clients, then the gateway to be monitored enters a relay mode, other repeaters except the new gateway enter a detection mode, and the new gateway enters a routing mode; a repeater in a detection mode detects how routing devices in a networking system form a network, and enables, by means of detection, the repeater in a detection mode to find a new gateway in a routing state or a routing device connected to the new gateway in a routing mode, to re-complete networking and form a child-mother routing network; detection refers to perceiving the existence of a main node (a new gateway in a routing mode) and establishing a network internal communication (Backhaul) with the main node; after networking is completed, the gateway to be monitored, the new gateway and other repeaters re-establish a connection with the client.

It should be noted that all repeaters in the system and the gateway to be monitored constitute a routing system, the initial state of the gateway to be monitored is a routing mode, and the initial state of all repeaters is a relay mode. In the present embodiment, a device in a relay mode is always searching for a device in a routing mode, or searching for a device in a relay mode which has been connected to a device in a routing mode; therefore, in cases where the routing system disconnects with all clients, the original routing connection relationship is just maintained, without specifically disconnecting with each device in the routing system, and after the gateway to be monitored is restarted to enter the relay mode and a new gateway is restarted to enter the routing mode, since the state of the gateway to be monitored changes to be a relay mode, the original routing connection relationship cannot satisfy the direct or indirect connection between all devices in the relay mode and the device in the routing mode; and therefore, the device in the relay mode will research for and establish a direct or indirect connection with the new gateway currently in the routing mode, and the routing connection relationship further changes.

It should be noted that, the DHCP server which performs gateway handover by the first gateway handover mode switches from the gateway to be tested to the new gateway.

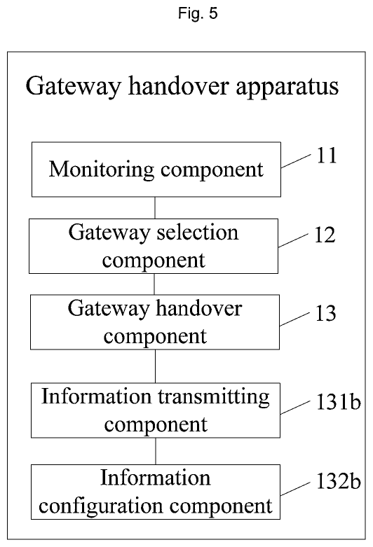

In yet another embodiment, referring to FIG. 5, the apparatus further includes:
an information transmitting component 131b configured to control the gateway to be monitored to transmit network configuration information to the new gateway; and
an information configuration component 132b configured to control the new gateway to perform the information configuration according to the network configuration information, so that the new gateway forwards, according to a NAT rule, the traffic for accessing the external network to the external network, and forwarding, to the internal network, the traffic returned by the external network according to the NAT rule.

In some embodiments, the gateway to be monitored transmits the network configuration information stored therein to the new gateway, the network configuration information including but not limited to a source IP, a destination IP, a source port, a destination port, various communication protocols, etc. which are recorded in the gateway to be monitored; The new gateway performs information configuration according to the network configuration information transmitted by the gateway to be monitored, so that the new gateway forwards, according to the NAT rule, the traffic for accessing the external network to the external network, and forwarding, to the internal network, the traffic returned by the external network according to the NAT rule.

In some embodiments, referring to FIG. 2 which is a data flow diagram of communication between other clients except a client of a new gateway itself and an external network after a gateway is handed over; in addition to a client of an RE (a new gateway) itself having a backup function, the traffic of other clients accessing the Internet (the external network) is forwarded to an original FAP according to a data flow direction before gateway handover, then is forwarded to an RE having a backup function by the original FAP, and then is forwarded to the external network by the RE having the backup function according to the NAT rule; when the RE having the backup function receives the traffic returned by the Internet, the RE forwards same to the gateway to be monitored according to the NAT rule, and then the gateway to be monitored transmits same to a corresponding client according to a data flow direction before gateway handover; the client of the new gateway itself refers to a client to which data that needs to be forwarded by the new gateway belongs when the client performs data transmission with an external network before gateway handover. The FAP refers to a device serving as a gateway in an internal network, a corresponding control system runs on the FAP, and can control an RE in the internal network, such as the rate of the Backhaul, on and off of a wireless Wi-Fi, on and off of an LED, and a networking password; besides the normal relay function, the RE may also respond to various operation commands issued by the FAP; in the present embodiment, the FAP and the RE may be the same in hardware, and the functions of the two may be controlled by software, so that mode switching may be performed on the FAP and the RE that has a backup function according to actual requirements.

The data flow direction of the communication between the client of the new gateway itself and the external network is that: the client of the new gateway itself transmits a traffic for accessing the external network to the new gateway, and the new gateway forwards the traffic to the external network; the traffic returned by the external network to the client of the new gateway is received by the new gateway and forwarded to the corresponding client of the new gateway.

It should be noted that the DHCP server that performs gateway handover by the second gateway handover mode is still on the gateway to be monitored.

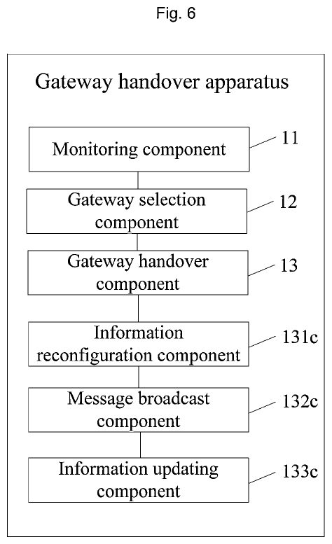

In another embodiment, referring to FIG. 6, the apparatus further includes:
an information reconfiguration component 131c, configured to control the gateway to be monitored to transmit network configuration information to the new gateway, so that the new gateway performs the information configuration according to the network configuration information;
a message broadcast component 132c configured to control the gateway to be monitored to broadcast a DHCP message after the new gateway completes the information configuration, and the DHCP message includes information about the new gateway; and
an information updating component 133c, configured to control other repeaters and the client to update network configuration information thereof according to the DHCP message, so that the client transmits the traffic for accessing the external network to the new gateway.

In some embodiments, the gateway to be monitored transmits a network data packet (network configuration information) to a selected temporary gateway (a new gateway), so as to enable the temporary gateway and cause the temporary gateway to perform information configuration (such as a router and a firewall) according to the network data packet; after completing information configuration, the temporary gateway transmits information indicating that information configuration has been completed to the gateway to be monitored, and after receiving from the temporary gateway the information indicating that information configuration has been completed, the gateway to be monitored broadcasts the DHCP message, and the DHCP message carries information about a new temporary gateway; after other devices (other repeaters and clients) receive the DHCP message, the other devices update their own network configuration information according to the DHCP message. Thereafter, the data transmission of the internal network and the external network is forwarded by the new gateway.

It should be noted that, when the third gateway handover mode is used to perform gateway handover, a client (such as a mobile phone or a PC) needs to adapt to a new protocol. The new protocol is to extend the existing DHCP protocol, and add a type of the DHCP message, named DHCPREOFFER(0x09); the format of the message is the same as that of DHCPOFFER; the message is actively transmitted by the DHCP server, and it is announced that parameters that the DHCP server wants to transmit to the client change (such as a default gateway change, a DNS server change, a static route change, or a change in other dhcp option fields) compared with the parameters previously received by the DHCP client; the message is actively transmitted by the DHCP server, and requests that the DHCP client in a BOUND state can respond to the type of the DHCP message. In addition, the type of message does not set a transaction ID. After receiving the type of message, the client should ignore the field, and then the client can independently choose to enter a DISCOVER state, or directly accept the parameters in the DHCPREOFFER message and enter a REQUESTING state.

It should be noted that the DHCP server that performs gateway handover by the third gateway handover mode is still on the gateway to be monitored.

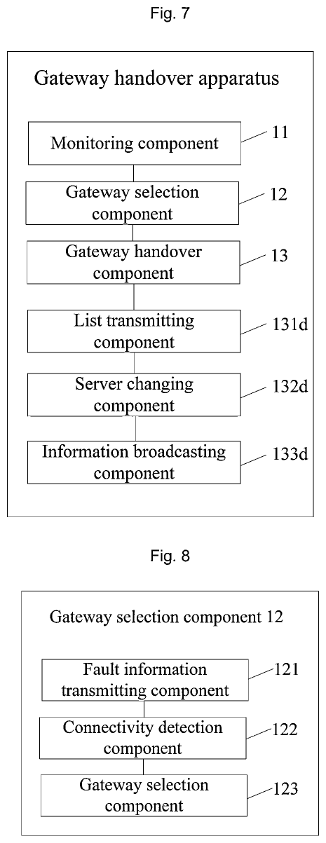

In yet another embodiment, referring to FIG. 7, the apparatus further includes:
a list transmitting component 131d configured to control the gateway to be monitored to transmit a client information list to the new gateway; and the client information list is lease information of the client;
a server changing component 132d, configured to change an IP address of the gateway to be monitored and an IP address of the new gateway, close the DHCP server of the gateway to be monitored, and start a DHCP server of the new gateway;
an information broadcasting component 133d, configured to control the new gateway to broadcast the IP address which is new and a MAC address thereof.

In some embodiments, the client information list stored in the gateway to be monitored is transmitted to the new gateway; and the client information list is lease information of the client, is information related to DHCP Lease, and includes all the necessary information such as an allocated client IP, a corresponding MAC and a lease; relevant information about the DHCP server itself, such as an address pool range, is always synchronous on various devices (including a gateway to be monitored, a new gateway and other repeaters) in an internal network, and is an inherent function already realized by the network system of the present embodiment; when being updated in a synchronization mechanism, the configuration will be transmitted to other devices by means of an inherent mechanism; each device has a set of complete configurations; if a certain configuration needs to be synchronized, the configuration item can be added to the original synchronization mechanism; the IP of the gateway to be monitored is set as the IP of the current new gateway, then the DHCP server of the gateway to be monitored is closed, the IP of the new gateway itself is set as the original IP of the gateway to be monitored, and then the DHCP server of the new gateway is enabled; the new gateway broadcasts the new IP address and the MAC address thereof, and announces a binding relationship between the current IP address and the MAC address thereof, so that a client (a mobile phone, a PC, etc.) can still directly transmit the traffic for accessing the Internet to the new gateway according to default gateway information which is previously acquired thereby. Such a gateway handover mode is almost not aware by the client; and the new gateway replaces, according to a synchronized client information list, the gateway to be monitored to begin to execute a work which should be undertaken by a normal DHCP server.

In yet another embodiment, referring to FIG. 8, the gateway selection component 12 specifically includes:
a fault information transmitting component 121 configured to control the gateway to be monitored to transmit failure information to repeaters in a networking in the case that the communication failure occurs in the ISP connected to the gateway to be monitored;
a connectivity detection component 122 configured to control the repeaters in the networking to detect a network connectivity thereof; and
a gateway selection component 123 configured to select the repeater having the backup gateway function as the new gateway according to the network connectivity of the repeaters.

In some embodiments, when it is detected that the gateway to be monitored is in a network fault, the gateway to be monitored transmits a message to a repeater in a network according to a network information list recorded thereon to report its own network failure, so that the repeater transmits, within a specified time, its own connectivity condition as a new gateway to the gateway to be monitored (the repeater may maintain an operation of detecting the connectivity of the Internet all the time, and may also perform detection after having received failure information reported by the gateway to be monitored); a repeater is selected as a new gateway according to the connectivity information reported by the repeaters and received by the gateway to be monitored.

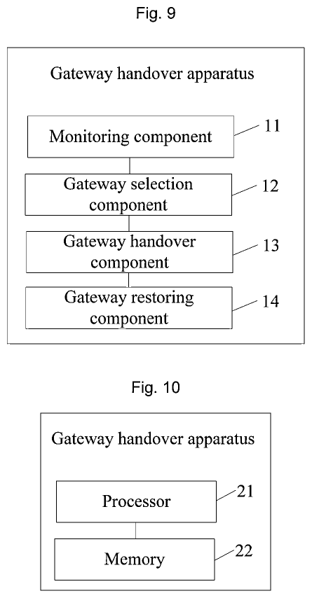

In yet another embodiment, referring to FIG. 9, the apparatus further includes: a gateway restoring component 14 configured to restore the network to an initial state in a case that it is detected that the communication in the ISP connected to the gateway to be monitored is restored to be normal.

In some embodiments, when it is detected that the communication of the ISP connected to the gateway to be monitored is restored to be normal, the network may be restored to an initial state according to a preset restoration manner, or a restoration manner may be selected by a user by means of a pop-up window but not limited to a pop-up window, and then the network is restored according to a received user selection.

Compared with the prior art, the gateway handover apparatus provided in the embodiments of the present disclosure can use a repeater in a network system as a new gateway, and select an appropriate gateway handover mode to perform gateway handover when a communication failure occurs in an ISP connected to a gateway to be monitored, thereby improving the adaptability of gateway backup, and the gateway handover can be realized only on a home router without additionally adding a hardware component. The method has the advantages of low cost and being applicable to a home scenario.

It should be noted that, for a specific working process of the gateway handover apparatus, reference may be made to the working process of the gateway handover method in the foregoing embodiment, and details are not repeatedly described herein.

Referring to FIG. 10 which is a structural block diagram of a preferred embodiment of a terminal device provided in a fourth aspect of the present disclosure. The terminal device includes a processor 21, a memory 22, and a computer program stored in the memory 22 and configured to be executed by the processor 21. When executing the computer program, the processor 21 implements steps in the foregoing gateway handover method embodiment, for example, steps S11 to S13 shown in FIG. 1: Alternatively, when executing the computer program, the processor 21 implements functions of each component in each apparatus embodiment, for example, the monitoring component 11.

In some embodiments, the computer program may be divided into one or more components, and the one or more components are stored in the memory 22 and executed by the processor 21 to realize the present disclosure. The one or more components may be a series of computer program instruction sections capable of performing a specific function, and the instruction sections are for describing the execution process of the computer program in the electronic device. For example, the computer program can be divided into a monitoring component 11, a gateway selection component 12 and a gateway handover component 13, and the specific functions of each component are as follows:
the monitoring component 11 is configured to monitor a communication state of an ISP connected to a gateway to be monitored;
the gateway selection component 12 is configured to select a repeater having a backup gateway function as a new gateway in a case that a communication failure occurs in the ISP connected to the gateway to be monitored;
the gateway handover component 13 is configured to select a preset gateway handover mode for gateway handover in response to a gateway handover 13 operation.

For a specific working process of each component, reference may be made to the working process of the gateway handover apparatus described in the foregoing embodiment, and details are not repeatedly described herein.

The terminal device may be a computing device such as a desktop computer, a notebook computer, a palmtop computer and a cloud server. The terminal device may include, but is not limited to, a processor 21 and a memory 22. A person skilled in the art may understand that the schematic diagram is only an example of a terminal device, and does not constitute a limitation on the terminal device. The terminal device may include more or fewer components than those shown in the figure, or combine some components, or have different components. For example, the terminal device can further include an input and output device, a network access device, a bus, etc.

The processor 21 may be a central processing unit (CPU), and may also be another general-purpose processor, a digital signal processor (DSP), an application specific integrated circuit (ASIC), a field-programmable gate array (FPGA), or another programmable logic device, a discrete gate or a transistor logic device, a discrete hardware component, or the like. The general-purpose processor may be a microprocessor, or the processor may be any conventional processor or the like. The processor 510 is a control center of the terminal device, and uses various interfaces and lines to connect all parts of the entire terminal device.

The memory 22 may be configured to store at least one of the computer program and the component. The processor 21 implements various functions of the terminal device by running or executing at least one of the computer program and the component stored in the memory 22 and invoking data stored in the memory 22. The memory 232 may mainly include a program storage area and a data storage area. The program storage area may store an operating system, an application program required by at least one function (such as a function for monitoring a communication state of an ISP connected to the gateway to be monitored, and a function for selecting a new gateway) and the like. The data storage area may store data (such as network configuration information and a firewall) created according to the running of the network. In addition, the memory 22 may include a high-speed random access memory, and can further include a non-volatile memory, such as a hard disk, a memory, a plug-in hard disk, a smart memory card (SMC), a secure digital (SD) card, a flash card, at least one magnetic disk storage device, a flash memory device, or another volatile solid-state storage device.

If the component integrated in the terminal device is implemented in the form of a software functional unit and is sold or used as an independent product, the integrated unit can be stored in a computer-readable storage medium. Based on such an understanding, the present disclosure can implement all or a part of the procedures in the methods of the above embodiments by instructing relevant hardware through a computer program. The computer program can be stored in a computer readable storage medium. When the computer program is executed by a processor, the steps of the above method embodiments can be implemented. In which, the computer program includes computer program codes which may be the form of source codes, object codes, executable files, certain intermediate, and the like. The computer readable medium may include any entity or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals, software distribution media, and the like.

A person of ordinary skill in the art would understand that all or some processes of the methods in the described embodiments may be completed by computer programs instructing relevant hardware. The programs may be stored in a computer readable storage medium. When the programs are executed, the processes of the described method embodiments can be included. The storage medium may be a magnetic disk, an optical disk, a read-only memory (ROM) or a random access memory (RAM).

The description above only relate to preferred embodiments of the present disclosure. It should be noted that for a person with ordinary skill in the art, several improvements and modifications can also be made without departing from the technical principle of the present disclosure, and these improvements and modifications shall also be considered as within the scope of protection of the present disclosure.

What is claimed is:

1. A gateway handover method, comprising:
monitoring a communication state of an Internet Service Provider (ISP) connected to a gateway to be monitored;
in a case that a communication failure occurs in the ISP connected to the gateway to be monitored, selecting a repeater having a backup gateway function as a new gateway; and
in response to a gateway handover operation, selecting a preset gateway handover mode for gateway handover;
wherein at least one gateway handover mode comprises at least one of a first gateway handover mode, a second gateway handover mode, a third gateway handover mode and a fourth gateway handover mode, the preset gateway handover mode is one of the at least one gateway handover mode; the first gateway handover mode comprises: controlling the gateway to be monitored to restart and enter a relay mode, and controlling the new gateway to restart and enter a routing mode; the second gateway handover mode comprises: in cases where a original data flow logic of an internal network is maintained unchanged, adding a process of controlling the gateway to be monitored to forward a traffic for accessing a external network to the new gateway for processing, and a process of controlling the new gateway to forward a traffic returned by the external network to the gateway to be monitored for processing; the third gateway handover mode comprises: controlling the gateway to be monitored to broadcast information about the new gateway for which information configuration has been completed, so that a client transmits the traffic for accessing the external network to the new gateway; the fourth gateway handover mode comprises: changing a Intellectual Property (IP) of the gateway to be monitored and a IP of the new gateway, and turning on a Dynamic Host Configuration Protocol (DHCP) server of the new gateway while turning off a DHCP server of the gateway to be monitored.

2. The gateway handover method according to claim 1, wherein the first gateway handover mode specifically comprises:
disconnecting the gateway to be monitored, the new gateway, and other repeaters in a networking from the client;
controlling the gateway to be monitored to restart and enter the relay mode, and controlling the new gateway to restart and enter the routing mode; and
establishing a connection of the gateway to be monitored, the new gateway and the other repeaters with the client.

3. The gateway handover method according to claim 1, wherein the second gateway handover mode specifically comprises:
controlling the gateway to be monitored to transmit network configuration information to the new gateway; and
controlling the new gateway to perform the information configuration according to the network configuration information, so that the new gateway forwards, according to a Network Address Translation (NAT) rule, the traffic for accessing the external network to the external network, and forwarding, to the internal network, the traffic returned by the external network according to the NAT rule.

4. The gateway handover method according to claim 1, wherein the third gateway handover mode specifically comprises:
controlling the gateway to be monitored to transmit network configuration information to the new gateway, so that the new gateway performs the information configuration according to the network configuration information;
after the new gateway completes the information configuration, controlling the gateway to be monitored to broadcast a DHCP message, wherein the DHCP message comprises information about the new gateway; and
controlling other repeaters and the client to update the network configuration information thereof according to the DHCP message, so that the client transmits the traffic for accessing the external network to the new gateway.

5. The gateway handover method according to claim 1, wherein the fourth gateway handover mode specifically comprises:
controlling the gateway to be monitored to transmit a client information list to the new gateway, wherein the client information list is lease information of the client;
changing an IP address of the gateway to be monitored and an IP address of the new gateway, closing the DHCP server of the gateway to be monitored, and starting the DHCP server of the new gateway;
controlling the new gateway to broadcast the IP address which is new and a Media Access Control Address (MAC) address thereof.

6. The gateway handover method according to claim 1, wherein in the case that the communication failure occurs in the ISP connected to the gateway to be monitored, selecting the repeater having the backup gateway function as the new gateway comprises:
in the case that the communication failure occurs in the ISP connected to the gateway to be monitored, controlling the gateway to be monitored to transmit failure information to repeaters in a networking;
controlling the repeaters in the networking to detect a network connectivity thereof; and
selecting the repeater having the backup gateway function as the new gateway according to the network connectivity of the repeaters.

7. The gateway handover method according to claim 1, wherein the method further comprises: in a case that it is detected that the communication in the ISP connected to the gateway to be monitored is restored to be normal, restoring the internal network to an initial state.

8. A terminal device, comprising a processor, a memory, and a computer program stored in the memory and configured to be executed by the processor, wherein when executing the computer program, cause the processor to:
monitor a communication state of an Internet Service Provider (ISP) connected to a gateway to be monitored;
in a case that a communication failure occurs in the ISP connected to the gateway to be monitored, select a repeater having a backup gateway function as a new gateway; and
in response to a gateway handover operation, select a preset gateway handover mode for gateway handover;
wherein at least one gateway handover mode comprises at least one of a first gateway handover mode, a second gateway handover mode, a third gateway handover mode and a fourth gateway handover mode, the preset gateway handover mode is one of the at least one gateway handover mode; the first gateway handover mode comprises: controlling the gateway to be monitored to restart and enter a relay mode, and controlling the new gateway to restart and enter a routing mode; the second gateway handover mode comprises: in cases where a original data flow logic of an internal network is maintained unchanged, adding a process of controlling the gateway to be monitored to forward a traffic for accessing a external network to the new gateway for processing, and a process of controlling the new gateway to forward a traffic returned by the external network to the gateway to be monitored for processing; the third gateway handover mode comprises: controlling the gateway to be monitored to broadcast information about the new gateway for which information configuration has been completed, so that a client transmits the traffic for accessing the external network to the new gateway; the fourth gateway handover mode comprises: changing a Intellectual Property (IP) of the gateway to be monitored and a IP of the new gateway, and turning on a Dynamic Host Configuration Protocol (DHCP) server of the new gateway while turning off a DHCP server of the gateway to be monitored.

9. A non-transitory computer readable storage medium, wherein the non-transitory computer readable storage medium comprises a stored computer program, wherein when the computer program runs, a device where the non-transitory computer readable storage medium is located is configured to cause the at least one processor to:
monitor a communication state of an Internet Service Provider (ISP) connected to a gateway to be monitored;
in a case that a communication failure occurs in the ISP connected to the gateway to be monitored, select a repeater having a backup gateway function as a new gateway; and
in response to a gateway handover operation, select a preset gateway handover mode for gateway handover;
wherein at least one gateway handover mode comprises at least one of a first gateway handover mode, a second gateway handover mode, a third gateway handover mode and a fourth gateway handover mode, the preset gateway handover mode is one of the at least one gateway handover mode; the first gateway handover mode comprises: controlling the gateway to be monitored to restart and enter a relay mode, and controlling the new gateway to restart and enter a routing mode; the second gateway handover mode comprises: in cases where a original data flow logic of an internal network is maintained unchanged, adding a process of controlling the gateway to be monitored to forward a traffic for accessing a external network to the new gateway for processing, and a process of controlling the new gateway to forward a traffic returned by the external network to the gateway to be monitored for processing; the third gateway handover mode comprises: controlling the gateway to be monitored to broadcast information about the new gateway for which information configuration has been completed, so that a client transmits the traffic for accessing the external network to the new gateway; the fourth gateway handover mode comprises: changing a Intellectual Property (IP) of the gateway to be monitored and a IP of the new gateway, and turning on a Dynamic Host Configuration Protocol (DHCP) server of the new gateway while turning off a DHCP server of the gateway to be monitored.

10. The gateway handover method according to claim 1, wherein monitoring the communication state of the ISP connected to the gateway to be monitored comprises:
detecting running state of the gateway to be monitored by monitoring a DNS domain name resolution request transmitted by a user and a response returned by the ISP according to the DNS domain name resolution request, or monitoring web page download status of the user.

11. The gateway handover method according to claim 2, wherein an initial state of the gateway to be monitored is a routing mod, an initial state of all repeaters is a relay mode.

12. The gateway handover method according to claim 3, wherein the network configuration information comprises a source IP, a destination IP, a source port, a destination port and communication protocols.

13. The gateway handover method according to claim 5, wherein the client information list is lease information of the client, and comprises an allocated client IP, a corresponding MAC and a lease.

14. The gateway handover method according to claim 1, wherein the method further comprises: in a case that it is detected that the communication in the ISP connected to the gateway to be monitored is restored to be normal, showing a pop-up window, so that a restoration manner is selected by a user.

15. The terminal device according to claim 8, wherein when executing the computer program, cause the processor further to:
disconnect the gateway to be monitored, the new gateway, and other repeaters in a networking from the client;
control the gateway to be monitored to restart and enter the relay mode, and control the new gateway to restart and enter the routing mode; and
establish a connection of the gateway to be monitored, the new gateway and the other repeaters with the client.

16. The terminal device according to claim 8, wherein when executing the computer program, cause the processor further to:
control the gateway to be monitored to transmit network configuration information to the new gateway; and
control the new gateway to perform the information configuration according to the network configuration information, so that the new gateway forwards, according to a NAT rule, the traffic for accessing the external network to the external network, and forward, to the internal network, the traffic returned by the external network according to the NAT rule.

17. The terminal device according to claim 8, wherein when executing the computer program, cause the processor further to:
control the gateway to be monitored to transmit network configuration information to the new gateway, so that the new gateway performs the information configuration according to the network configuration information;
after the new gateway completes the information configuration, control the gateway to be monitored to broadcast a DHCP message, wherein the DHCP message comprises information about the new gateway; and
control other repeaters and the client to update the network configuration information thereof according to the DHCP message, so that the client transmits the traffic for accessing the external network to the new gateway.

18. The terminal device according to claim 8, wherein when executing the computer program, cause the processor further to:
control the gateway to be monitored to transmit a client information list to the new gateway, wherein the client information list is lease information of the client;
change an IP address of the gateway to be monitored and an IP address of the new gateway, close the DHCP server of the gateway to be monitored, and start the DHCP server of the new gateway;
control the new gateway to broadcast the IP address which is new and a MAC address thereof.

19. The terminal device according to claim 8, wherein when executing the computer program, cause the processor further to:
in the case that the communication failure occurs in the ISP connected to the gateway to be monitored, control the gateway to be monitored to transmit failure information to repeaters in a networking;
control the repeaters in the networking to detect a network connectivity thereof; and
select the repeater having the backup gateway function as the new gateway according to the network connectivity of the repeaters.

20. The terminal device according to claim 8, wherein when executing the computer program, cause the processor further to:
in a case that it is detected that the communication in the ISP connected to the gateway to be monitored is restored to be normal, restore the internal network to an initial state.
